(19) United States
(12) Patent Application Publication
(10) Pub. No.: US 2013/0198596 A1
(43) Pub. Date: Aug. 1, 2013

(54) LEGAL DOCUMENT ANALYZER AND PRESENTER

(71) Applicants: Mark C. Angelillo, New York, NY (US); Eric I. Moskowitz, New York, NY (US)

(72) Inventors: Mark C. Angelillo, New York, NY (US); Eric I. Moskowitz, New York, NY (US)

(21) Appl. No.: 13/359,712

(22) Filed: Jan. 27, 2012

(51) Int. Cl. G06F 17/00

(52) U.S. Cl. 715/205; 715/200

(57) ABSTRACT

A document analyzer and presenter is capable of automatically analyzing and formatting unformatted documents and presenting them to the user. The document analyzer and presenter may be implemented on a single computer or over a plurality of electronic devices connected to each other by a network. Formatted documents are presented to the user in a viewing window. Key sections and terms are hyperlinked to each other and the user's history of actions are tracked and displayed to the user.

### CROSS REFERENCE TO RELATED APPLICATIONS

The present application does not claim the benefit of a U.S. Provisional Application or any foreign filing.

### FIELD OF THE INVENTION

The field of the present invention generally relates to the electronically-enabled automated formatting and analysis of legal documents.

### BACKGROUND OF THE INVENTION

Legal documents are now the practical means by which nearly all business is conducted for commercial entities and private individuals alike. Legal documents are used, among other things, to formalize business agreements, secure employment, and buy, sell or lease significant assets, such as real estate. Unfortunately, legal documents can be very difficult to read and comprehend, even for lawyers. These documents are designed to enumerate the various specific privileges and responsibilities of both parties. Over time, legal documents have grown more complex and voluminous as lawyers have addressed emerging issues, which have made them more difficult for the lay person to understand.

Another trend sweeping the worlds of business and commerce is the increasingly electronic nature of transactions. Today, most contracts and agreements are drafted, reviewed and shared electronically. They may be downloaded from a website or exchanged through electronic mail (email) or another application. They also may be stored electronically on a stable medium and physically shared by one or more electronic devices. This trend means that a great many documents are stored electronically, or are otherwise accessed in electronic format.

What is needed is a way to prepare and present legal documents to users that significantly aids the user in understanding their content.

What is also needed is a way to prepare and present legal documents to users that allows users to easily and intuitively navigate legal documents.

What is needed is for the formatting and analysis of legal documents to be accomplished with legal documents from any source without any additional work or analysis from the drafter of the legal document.

What is further needed is for the formatting and analysis to be done without relying on the user or other person to mark up, format or otherwise analyze the legal document.

### SUMMARY OF THE INVENTION

This summary is provided to introduce (in a simplified form) a selection of concepts that are further described below in the Detailed Description. This summary is not intended to identify key features of the claimed subject matter, nor is it intended to be used as an aid in determining the scope of the claimed subject matter.

The recent trends in networking and commerce makes it possible to leverage the tremendous computing power of both the server and cloud platforms, as well as local electronic devices like personal computers (PCs) and mobile devices (such as laptops, tablet computers, smartphones, etc.), to automatically format and analyze legal documents. Embodiments of the present invention take a legal document inputted into the system via a scanner, or emailed or sent from another computer, or created in a word processing or other such program, and automatically parses through it. The parser searches for titles of sections, definitions of terms, dates, names of parties and other important information. From the information it finds, it is able to reformat the document to make it easier for a user to understand its contents. For instance, definitions of terms are linked to the terms as they are presented in the legal document. The titles of sections are navigable via the user interface. Moreover, user actions are tracked via an interactive history feature. Furthermore, a user can interact with the document in the same way that they would interact with a document in a word processor or in a web browser. The formatted document can be saved or transferred to another computer (such as through email or through an Internet “push” technology). Also, implementations of the present invention may keep multiple formatted legal documents and provide links between the document for easy access and to facilitate a better understanding of the documents.

In overcoming the above disadvantages associated with modern document analysis and presentation, this system for analyzing, formatting and presenting a legal document includes, but is not limited to, an electronic device for receiving an unformatted legal document; an electronic device for parsing the document for structural elements of the legal document; an electronic device for presenting a formatted document wherein the structural elements are identified to a user and the document is navigable by reference to structural elements of the legal document. These electronic devices are either directly or indirectly coupled to each other in such a way as to facilitate communication between these devices.

In accordance with an aspect of the present invention, the formatted document is presented to the user as a navigable, marked-up document.

In accordance with an aspect of the present invention, the formatted document is a hypertext mark-up language (HTML) document.

In accordance with an aspect of the present invention, the parsing of the document further includes the parsing the document for at least one of titles, section headings, definitions of terms, names of parties, dates, and cross-references to other sections of the document.

In accordance with the aspect of the present invention, the parsing of the document further comprises parsing the document for at least one of references to other private or public, formatted or unformatted documents accessible during the parsing.

In accordance with an aspect of the present invention, the presenting of the formatted document is done by the presenting the formatted document in a viewer window with a panel showing the history of the manipulations performed on the formatted document by at least the user or the parser.

In accordance with another aspect of the present invention, a computer readable medium encoded with computer readable instructions, which when executed, perform a method for of analyzing, formatting and presenting a legal document, including receiving an unformatted legal document, parsing the document for structural elements of the legal document and presenting a formatted document. The structural elements are identified to a user and the document is navigable by reference to structural elements of the legal document.

In accordance with an aspect of the present invention, a method of analyzing, formatting, and presenting a legal document includes, but is not limited to, receiving an unformatted legal document in an electronic format at an electronic device, parsing the document for structural elements of the legal document by a parser hosted on an electronic device, and presenting a formatted document on an electronic device. The structural elements are identified to a user and the document is navigable by reference to structural elements of the legal document.

### BRIEF DESCRIPTION OF THE DRAWINGS

Preferred and alternative examples of the present invention are described in detail below with reference to the following Figure drawings:

FIG. 1 illustrates a computer network comprised of various electronic devices configured to operate an embodiment of the present invention.

FIG. 2 illustrates a computer system comprised of various elements configured to operate an embodiment of the present invention.

FIG. 3 illustrates a computer network comprised of various electronic devices including a server cloud configured to operate an embodiment of the present invention.

FIG. 4 illustrates a flowchart for converting an unformatted document into a formatted document in accordance with an embodiment of the present invention.

FIG. 5 illustrates a flowchart showing a method for converting an unformatted document into a formatted document.

FIG. 6 illustrates a view of the formatted document presented to the user on the user's display.

FIG. 7 illustrates another view of the formatted document presented to the user on the user's display.

FIG. 8 illustrates another view of the formatted document presented to the user on the user's display.

### DETAILED DESCRIPTION

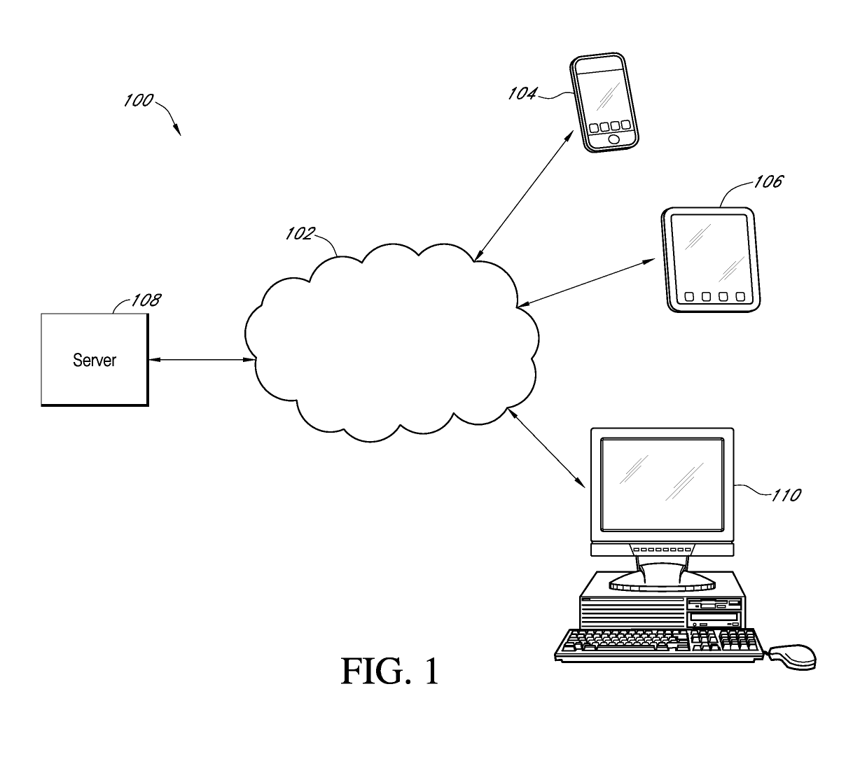

In accordance with an exemplary embodiment of the present invention, FIG. 1 illustrates a computer network 100 comprised of various elements. The computer network 100 may have a variety of end user devices interact with it. The computer network can support connections to smart phones 104, tablet computers 106 and desktop computers 110, but the present invention is not so limited. The computer network may have laptops workstations, other servers, cell phones, personal data assistants (PDAs), gaming systems, and other electronic devices connected to it. In the present embodiment, many elements of the invention are present at the server 108. The network server 108 is connected to the end user devices through a series of network connections 102. In an embodiment of the present invention, the series of network connections are the Internet. In other embodiments of the present invention, the series of network connections may be a local area network (LAN) or a virtual private network (VPN). Communications between the network server 108 and the various electronic devices may or may not be encrypted. Furthermore, as part of a security and privacy protocol, the identities of the various components communicating with each other may be verified with each other through the use of passwords or some other security procedure. The series of network connections 102 may include both wireless and wireline connections. In an embodiment of the present invention, all connections in the series of network connections 102 may be wireless. In an alternative embodiment, all connections in the series of network connections 102 may be wireline. The various end user devices (smart phone 104, tablet computer 106, desktop computer 110) may be connected to the series of network connections 102 through either a wireless connection or a wireline connection.

Various sub-components of the document analyzer and formatter may be implemented on the various elements of the computer network. In an embodiment of the present invention, the client device such as the tablet computer 106 or personal computer 110 serve only as the user interface and display while all the processing required for the analyzing and formatting of the unformatted document is performed at the server 108. In other embodiments, the balance of processing duties may be more balanced between the server 108 and the client device or devices. In an embodiment of the present invention, the unformatted document is uploaded from the client device. The unformatted document may have been authored on the client device or it may be saved on the client device. Furthermore, the unformatted document may be scanned into the client device through a scanner or other computer peripheral device. The unformatted document may also be served on another computer such as another server (not shown) accessible to either the client device(s), the server 108, or both.

The unformatted document inputted into the analyzer and formatter may be stored in a variety of file types including, but not limited to, .doc and docx (Word™ documents), .pages (pages™ documents), HTML files, .tif files, pdf files, and any other file type capable of storing a document. The unformatted document to be processed by the analyzer and formatter may be loaded via an attachment from a email (typically sent from client to the server 108) or by the directing the analyzer and formatter to upload the unformatted document from a site accessible with a web address. Unformatted documents may be uploaded one at a time or several at a time.

It is important to note that the unformatted file used as input to the document analyzer and formatter may not be completely unformatted. It may include any type of formatting common to text files including but not limited to indentation, capitalization, margins, titles, page numbers, etc. It is not required to have any special formatting that provides clues to the analyzer and formatter on how to prepare the document for viewing by the user. The analyzer and formatter is configured to accept any document as input and apply its parser to find components within the unformatted document to prepare the output file.

Once the unformatted document has been transformed into a formatted document, it is ready to be presented to the user. In an embodiment of the present invention, the formatted document is sent to the client device as an HTML or XML file as an email attachment. The user then uses any program capable of reading the file to view it. In another embodiment of the present invention, the formatted file is made available on the server 108 and is viewable from the client device by using a web browser or a specialized application.

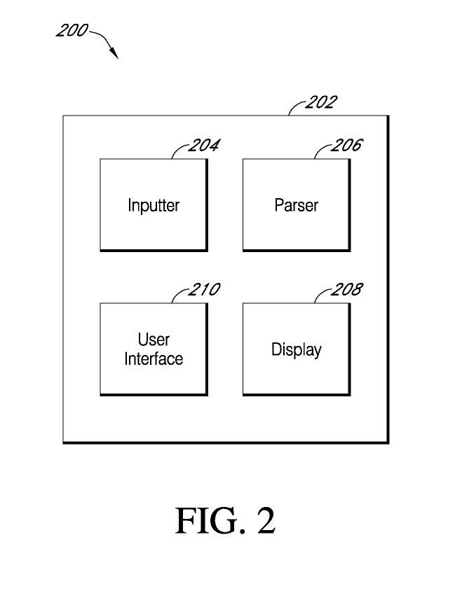

FIG. 2 illustrates a computer system 200 comprised of various elements configured to operate an embodiment of the present invention. In the present embodiment of the invention, the entire system is housed in the same computer system 202. The physical system includes an Inputter 204, a Parser 206, a User Interface 210 and a Display 208. The Inputter 204 may be any electronic input device known in the art including, but not limited to, a scanner, a network connection capable of receiving electronic communication, a disk drive, universal serial bus (USB) drive, or any other similar electronic device. The Inputter 204 receives the documents to be transformed by the embodiment of the invention. In an embodiment of the present invention, the documents are scanned into the computer system 202 through a scanner. In an embodiment of the present invention, the documents may be received by the Inputter 204 through a network connection capable of sending and receiving email or supporting file transport protocol (ftp) or an equivalent protocol or method.

The Parser 206 parses the document and transforms it into a formatted document in accordance with embodiments of the present invention. In an embodiment of the present invention, the Parser 206 is implemented by executable computer code executed on a microprocessor such as an Intel Core i5™ processor. In alternative embodiments, other processors or more than one processor may be used. The user interacts with the computer system 202 through a user interface 210 and a display 208. The user interface 210 may be a keyboard, a keyboard and mouse or trackpad, or a touchscreen. In an embodiment of the present invention, the user interface 210 may be voice-driven. In an embodiment of the present invention, the user interface 210 may utilize one or more of the features mentioned above to interface with the user. In an embodiment of the present invention, the formatted document may be presented on a display 208. The display 208 may a liquid crystal display (LCD), a cathode ray tube (CRT) or a projector or any equivalent device that can display text and graphics to a user in 2-D or 3-D. In the embodiment illustrated by FIG. 2, the Inputter 204, Parser 206, User Interface 210 and Display 208 are all housed in the same computer system, but the present invention is not so limited. Each of these components may be housed in a separate computer system and networked together.

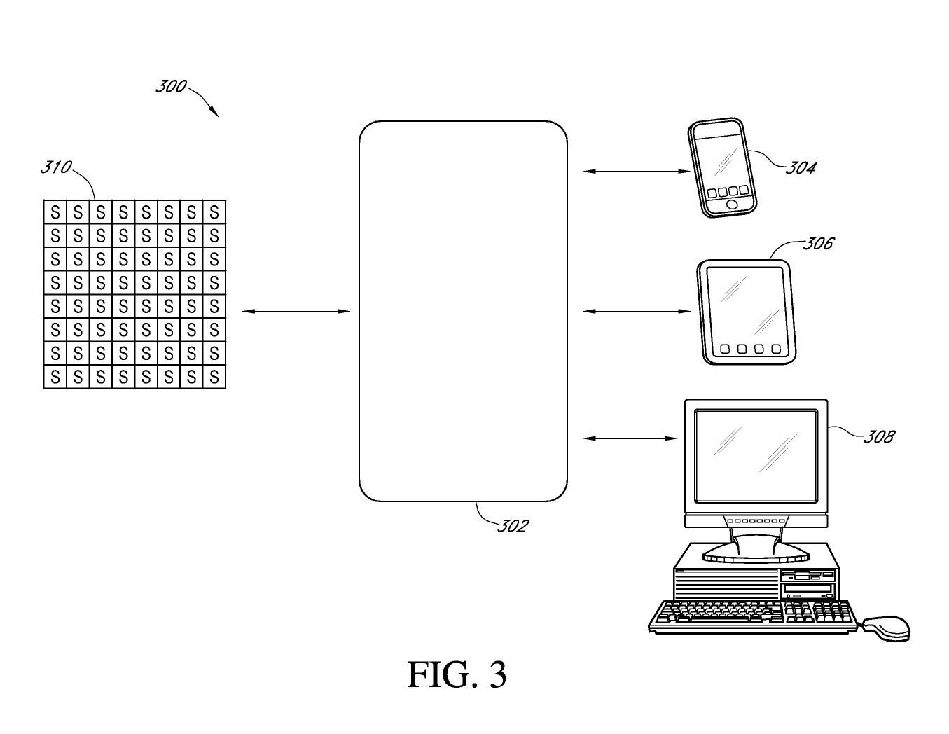

FIG. 3 illustrates a computer network 300 comprised of various elements. The computer network 300 may have a variety of end user devices interact with it. The computer network 300 can support connections to smart phones 304, tablet computers 306 and desktop computers 308, but the present invention is not so limited. The computer network 300 may have laptops, workstations, other servers, cell phones, personal data assistants (PDAs), gaming systems and other electronic devices connected to it. In the present embodiment, many elements of the invention are present at the server cloud 310. The server cloud 310 is constructed out of a set of servers. The server cloud 310 may be made up of a single server or a collection of servers cooperating to carry out the work of the invention. The servers in the server cloud may either do separate parts of the task as the invention is split up into separate steps. For example, one server can be employed for inputting, one for parsing, one for display, etc., or the server cloud may make use of distributed computing to break those tasks down further and spread them across networked servers. This works using an algorithm such as the map-reduce algorithm to split the atomic tasks into tasks that is processed independently on individual hardware. The network server cloud 310 is connected to the end user devices through a series of network connections 302. In an embodiment of the present invention, the series of network connections are the Internet. In other embodiments of the present invention, the series of network connections may be a local area network (LAN) or a virtual private network (VPN). Communications between the network server cloud 310 and the various electronic devices may be encrypted or not. Furthermore, as part of a security and privacy protocol, the identities of the various components communicating with each other may be verified with each other through the use of passwords or some other procedure. The series of network connections 302 may include both wireless and wireline connections. In an embodiment of the present invention, all connections in the series of network connections 302 may be wireless. In an alternative embodiment, all connections in the series of network connections 302 may be wireline. The various end user devices (smart phone 304, tablet computer 306, desktop computer 308) may be connected to the series of network connections 302 through either a wireless connection or a wireline connection.

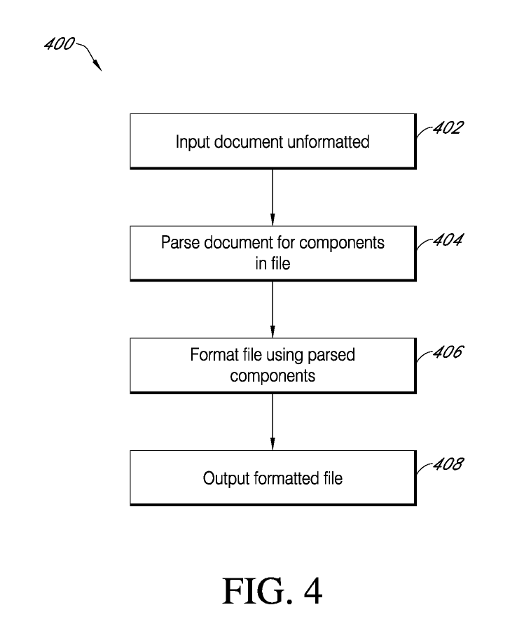

In accordance with an embodiment of the present invention, FIG. 4 illustrates a flowchart for converting an unformatted document into a formatted document 400. In block 402, the unformatted document is inputted into the system. The document may be inputted into the system by scanning a paper copy of the document with a scanner. The document may be inputted into the system by receiving the document via a network connection as email, an email attachment, or through a file transfer application. The document also may be present on a hard disk, or inputted from a USB device, or optical disk, or some other removable media. Once the unformatted document is inputted into the system, the unformatted document is parsed for components in the file, shown at block 404. The components of the file for which the parser searches can include a variety of content which aids the parser in formatting the unformatted file. In an embodiment of the present invention, the parser parses or scrapes certain components of the unformatted document, included, but not limited to, the title of the document, names of parties, dates, section numbers and headings, beginnings and ends of sections, cross-references to other sections, defined terms and corresponding definitions, references to other formatted or unformatted documents, references to other publicly available sources, references to other business-specific documents and substantive content from other text passages included in the unformatted document.

In the present embodiment, a formatted version of the unformatted document is created, as shown in block 406, by using the components parsed in block 404. The formatted document is created by using the components in the unformatted document to automatically format the formatted document. In an embodiment of the present invention, the outputted formatted file, outputted in block 408, is formatted to be viewable in a web browser. The formatted file may be formatted using hypertext mark-up language (HTML) or extensible markup language (XML). In an embodiment of the present invention, the formatted document may use another markup language or formatting technique. Furthermore, in an embodiment of the present invention, the formatted document may be stored as file readable in a word processor or in a proprietary application. The formatted document may be stored either locally on the device in which it is viewed or it may be stored on a server.

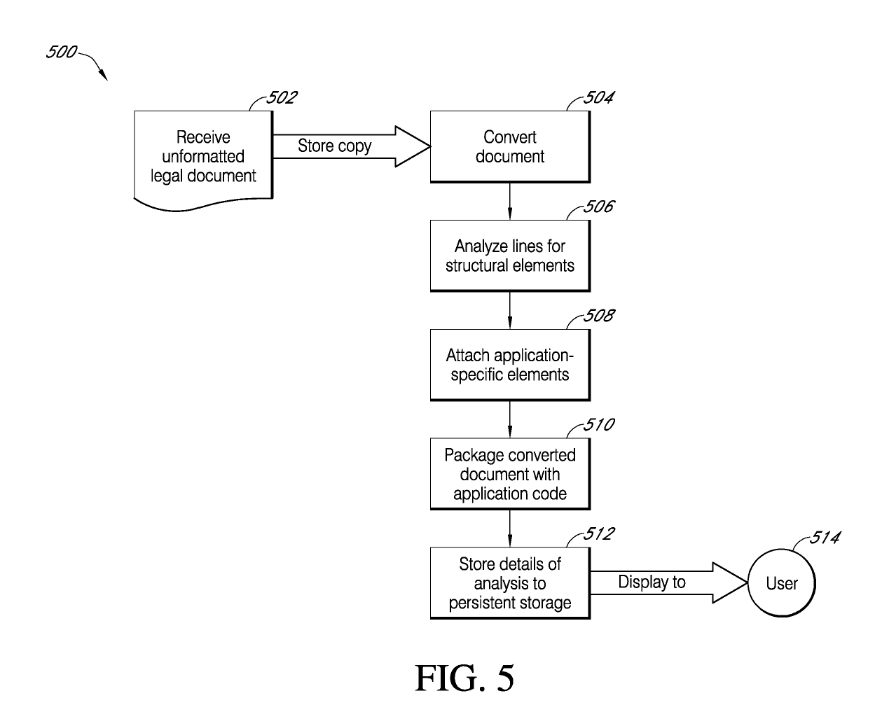

In accordance with an embodiment of the present invention, FIG. 5 illustrates a flowchart showing a method 500 for converting an unformatted document into a formatted document. In the present embodiment, the unformatted document is a legal document. In block 502, the unformatted legal document is received. The unformatted legal document may be scanned in by a scanner, or it may received as an email attachment. A copy of the unformatted legal document is then stored. The unformatted legal document may be stored anywhere on the computer system or computer network used to practice the embodiment of the present invention. The unformatted legal document may be stored locally at the client device where the user is interacting with the document analysis and formatting system. The unformatted legal document may be stored at a server networked to the user's client device. Once a copy of the unformatted legal document is stored, the document is converted, as shown in block 504. The converter block 504 prepares the document for the parsing. The parser then analyzes each line of the inputted unformatted legal document to find structural elements in the text of the document, as shown in block 506. As previously mentioned, the structural elements or components of the unformatted document may include, without limitation, the title of the document, names of parties, dates, section numbers and headings, beginnings and ends of sections, etc. These structural elements from the inputted unformatted legal document are then used by the document analyzer and formatter to construct the formatted document to be outputted to the user 514. At block 508, application-specific elements are attached to the document. At block 510, the converted document is packaged with application code. The details of the analysis of the legal document are now stored in block 512. The document has now been formatted for easy use, navigation and manipulation by the user 514, and is now displayed to the user 514.

The analysis and formatting of the original unformatted document is done automatically by the system without the aid or oversight of the user or any other human being. In an embodiment of the present invention, the user may control what structural components or terms the parser uses when analyzing the inputted file. Once the user has specified these terms, the parser then analyzes the document without any further input or control by the user or any other human being. In other words, the document and analysis of the inputted original unformatted files has been entirely automated.

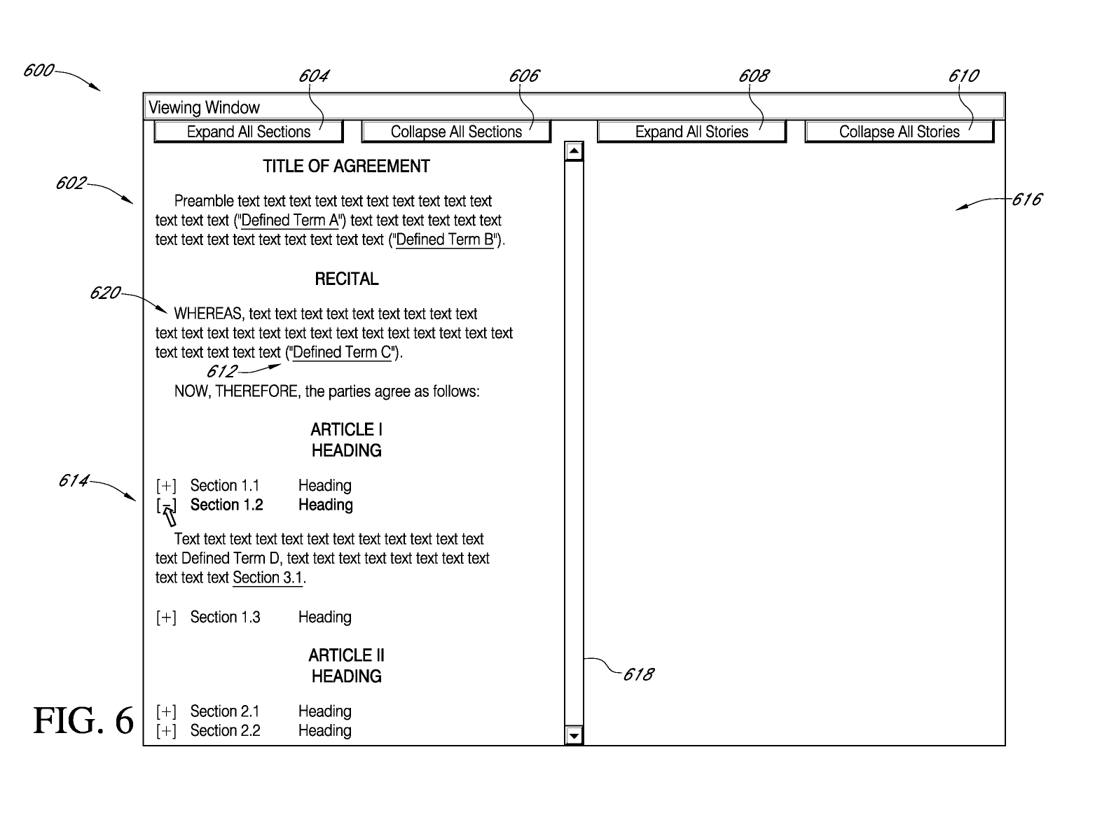

In accordance with an embodiment of the present invention, FIG. 6 illustrates a view of the formatted document presented to the user on the user's display. The formatted document along with various tools and windows are presented to the user in a viewing window 600. In the present embodiment, the viewing window 600 is split into two viewing sections separated by a vertical scrolling bar 618. The left viewing section 602 contains the formatted text of the formatted document selected for viewing. The formatted text includes the text 620 of the formatted document. While this text will include headings and text arranged into paragraphs and so on, it also contains selectable, hyperlinked portions 612 within the text. Each section of the formatted document may be expanded or closed by selecting the “+/−” or similar button next to it with the cursor 614. Typically, the cursor 614 is controlled by the user manipulating a trackpad or mouse or other pointing device, but the invention is not so limited. The cursor 614 may be controlled by the user through the use of arrow keys or some other set of keys typically found on a keyboard. If the user interface or display includes a touch screen, the user may control the cursor 614 or directly select portions of the formatted text by interacting with the touch screen. Alternatively or in addition to the previously discussed methods of controlling the cursor 614 and selecting selectable portions of the formatted document, the user may be able to utilize keyboard controls commonly known as “shortcuts” to navigate the formatted document.

In the viewing window 600 illustrated in FIG. 6, the user can scroll through the formatted text selecting the arrows on the scroll bar 618 or manipulating a selector (not shown) and moving it up and down. The viewing window 600 also includes selectable tools, tabs, and windows. The “Expand All Sections” tab 604 expands out all sections of the formatted documents so that none of the document's text remains hidden. The “Collapse All Sections” tab 606 closes all sections, hiding all of their text. The “Expand All Stories” tab 608 expands out all stories (none shown in FIG. 6) to be displayed in the right viewing section 616 of the viewing window 600. The “Collapse All Stories” tab 610 collapses all stories (none shown in FIG. 6) to be displayed in the right viewing section of the viewing window 600.

In an embodiment of the present invention, the viewing window 600 may be a window in a web browser. As such, the tools, tabs, bars and windows commonly included in the web browser interface may be included along with the tabs shown in FIG. 6. In other embodiments of the present invention, the viewing window 600 may be incorporated into a word processing application. In addition to the menus and tabs shown in the FIG. 6, the viewing window may include the typical menus such as “edit,” “format,” “font,” “tools,” etc. Additional icons that may be available for selection include “open file, ” “save file,” etc.

In an embodiment of the present invention, the viewing window 600 may be included in a stand-alone application or applet. The application, or “app,” may be optimized to work on certain hardware, especially tablet computers like the Apple™ iPad™, or for smart phones running iOS™ or Android™ operating systems.

The present embodiment has been shown with only four tabs and two viewing windows, but the present invention is not so limited. The viewing window may include other windows to present multiple portions of the same formatted document or portions of different formatted documents. The windows may be arranged side-by-side or may overlap or may be split one on top of the other. Menus, tabs or buttons may be presented to the user at the top of the window, as in FIG. 6 or on any portion of the screen. Additional menus may contain features for opening and saving documents (both formatted and unformatted), highlighting and bookmarking the document, posting comments in the document, editing, printing, etc.

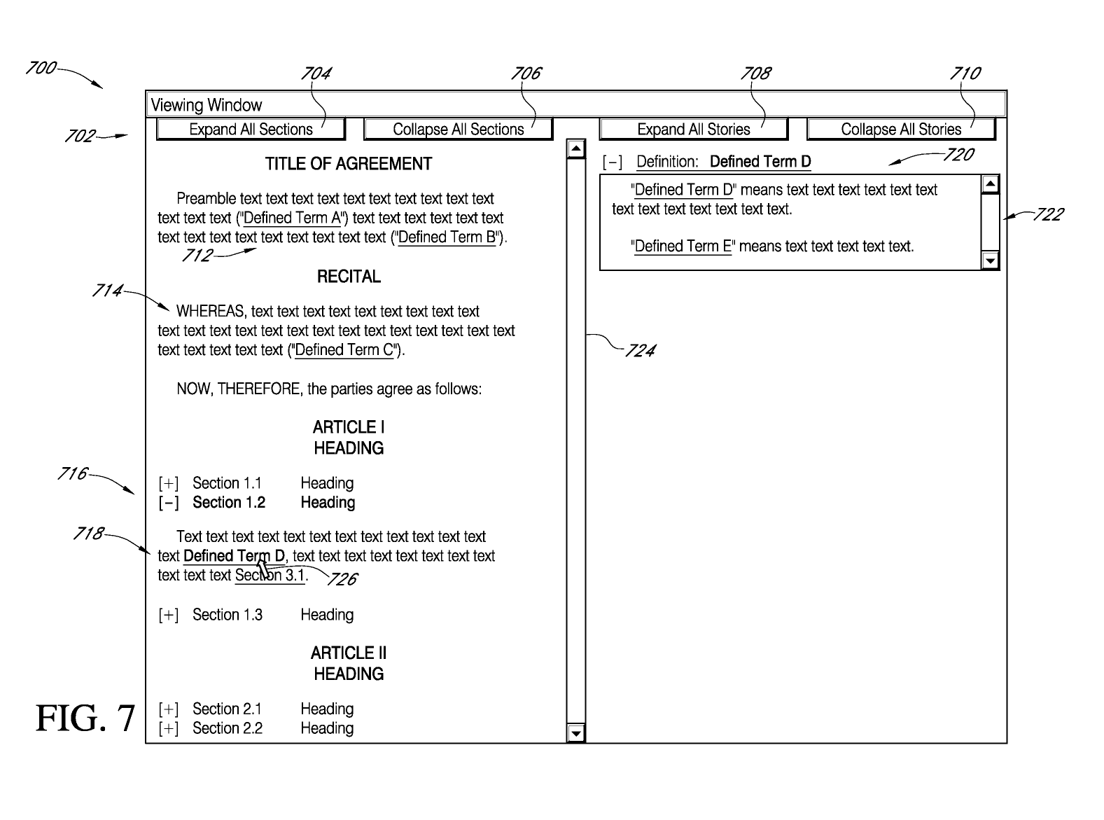

In accordance with an embodiment of the present invention, FIG. 7 illustrates a view of the formatted document presented to the user on the user's display. The formatted document along with various tools and windows are presented to the user in a viewing window 700. In the present embodiment, the viewing window 700 is split into two viewing sections separated by a vertical scrolling bar 724. The left viewing section 702 contains the formatted text of the formatted document selected for viewing. The formatted text includes the text 712 of the formatted document. Much like a word processing document, the text may also contain additional formatting like indentation and capitalization of paragraphs 714. While this text will include headings and text arranged into paragraphs and so on, it also contains selectable, hyperlinked portions 718 within the text with the cursor 726. Each section of the formatted document may be expanded or closed by selecting the “+/−” or similar button 716 next to it. Typically, the cursor 726 is controlled by the user manipulating a trackpad or mouse or other pointing device, but the invention is not so limited. The cursor 726 may be controlled by the user through the use of arrow keys or some other set of keys typically found on a keyboard. If the user interface or display includes a touch screen, the user may control the cursor 726 or directly select portions of the formatted text by interacting with the touch screen. Alternatively or in addition to the previously discussed methods of controlling the cursor 726 and selecting selectable portions of the formatted document, the user may be able to utilize keyboard controls commonly known as “shortcuts” to navigate the formatted document.

In the viewing window 700 illustrated in FIG. 7, the user can scroll through the formatted text selecting the arrows on the scroll bar 724 or manipulating a selector (not shown) and moving it up and down. The viewing window 700 also includes selectable tools, tabs, and windows. The “Expand All Sections” tab 704 expands out all sections of the formatted documents so that none of the document's text remains hidden. The “Collapse All Sections” tab 706 closes all sections, hiding all of their text. The “Expand All Stories” tab 708 expands out all stories to be displayed in the right viewing section 720 of the viewing window 700. The “Collapse All Stories” tab 710 collapses all stories to be displayed in the right viewing section of the viewing window 700. The user can scroll through the stories or previous definitions text by selecting the arrows on the scroll bar 722 or manipulating a selector (not shown) and moving it up and down. In the present embodiment of the invention, the past actions of the user are tracked in the left viewing window 720. As previously mentioned, the history of the user actions can be accessed by scrolling up or down. It also may be searchable. As the user selects a selectable term in the left viewing window 702 or otherwise performs an action on the formatted document, it is automatically added to the right viewing window 720. In the present embodiment, the action is listed on its own line in the right viewing window 720 with the most recent actions being placed at the top, but the present invention is not so limited. Actions may be listed with the newest entries being placed at the bottom or with the actions sharing lines.

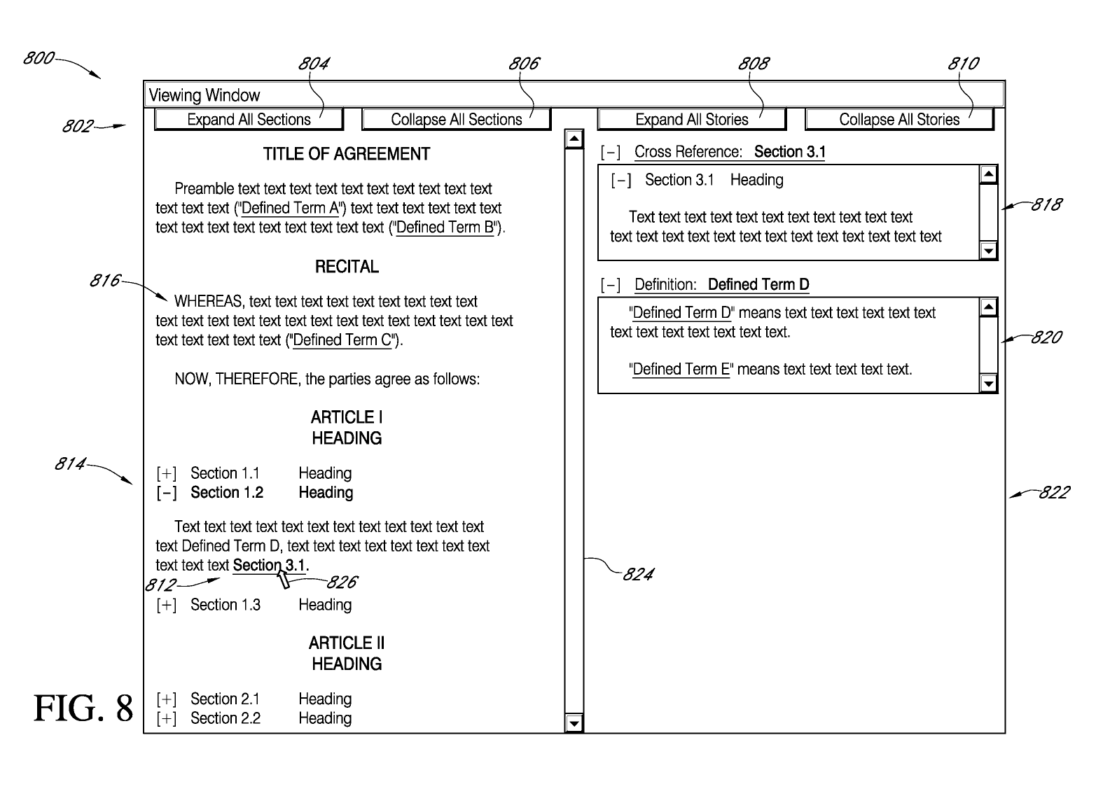

In accordance with an embodiment of the present invention, FIG. 8 illustrates a view of the formatted document presented to the user on the user's display. The formatted document along with various tools and windows are presented to the user in a viewing window 800. In the present embodiment, the viewing window 800 is split into two viewing sections separated by a vertical scrolling bar 824. The left viewing section 802 contains the formatted text of the formatted document selected for viewing. The formatted text includes the text 816 of the formatted document. While this text will include headings and text arranged into paragraphs and so on, it also contains selectable, hyperlinked portions 812 within the text selectable with the cursor 826. Each section of the formatted document may be expanded or closed by selecting the “+/−” or similar button 814 next to it. Typically, the cursor 826 is controlled by the user manipulating a trackpad or mouse or other pointing device, but the invention is not so limited. The cursor 826 may be controlled by the user through the use of arrow keys or some other set of keys typically found on a keyboard. If the user interface or display includes a touch screen, the user may control the cursor 826 or directly select portions of the formatted text by interacting with the touch screen. Alternatively or in addition to the previously discussed methods of controlling the cursor 826 and selecting selectable portions of the formatted document, the user may be able to utilize keyboard controls commonly known as “shortcuts” to navigate the formatted document.

In the viewing window 800 illustrated in FIG. 8, the user can scroll through the formatted text selecting the arrows on the scroll bar 824 or manipulating a selector (not shown) and moving it up and down. The viewing window 800 also includes selectable tools, tabs, and windows. The “Expand All Sections” tab 804 expands out all sections of the formatted documents so that none of the document's text remains hidden. The “Collapse All Sections” tab 806 closes all sections, hiding all of their text. The “Expand All Stories” tab 808 expands out all stories to be displayed in the right viewing section 822 of the viewing window 800. The “Collapse All Stories” tab 810 collapses all stories to be displayed in the right viewing section of the viewing window 800. When more than one type of action has been selected by the user, more than one mini-panels are opened by in the right viewing section 822. In the FIG. 8, two mini-panels are shown: one entitled “Cross Reference: Section 3.1,” and the other entitled “Definition: Defined Term D.” Each of these mini-panel panels has their own scroll bar (818 and 820) to provide the user with a way to surf through past actions, or “stories.” The user can scroll through the stories or previous definitions text by selecting the arrows on the scroll bar (not shown) or manipulating a selector (not shown) and moving it up and down. In the present embodiment of the invention, the past actions of the user are tracked in the right viewing window 822. As previously mentioned, the history of stories can be accessed by scrolling up or down. It also may be searchable. As the user selects a selectable term in the left viewing window 802 or otherwise performs an action on the formatted document, it is automatically added to the right viewing window 822.

In an embodiment of the present invention, the analyzer and formatter formats the outputted document in such a way to aid a user in navigating and understanding its content. The view of the formatted document may start with a “Table of Contents” constructed from the inputted unformatted document by the parser for easy browsing. Alternatively, the default view first shown to the user when the formatted document is load may be the formatted document with all the section headings collapsed. These section headings may be expanded and collapsed at the user's discretion. The defined terms found in the unformatted document are hyperlinked to their definitions in document. Cross-references to other sections found in the unformatted document are hyperlinked to applicable sections of document. Moreover, the viewer's user interface may include a reverse cross-reference tool, which lists other provisions that reference a given provision, either directly (e.g., by section reference) or indirectly (e.g., by superseding all other provisions in a document). The viewer's user interface may also include a search tool. The search tool may list all other sections containing a search term inputted or selected by the user. The viewer and user interface may also include a previewer for showing term usage found in the unformatted document.

The viewer user interface may provide a variety of tools to the user to help the user flag important sections of the outputted formatted document. The viewer user interface may include bookmarking and highlighting of passages of the formatted documents. The viewer user interface may also allow the user to post comments or other notes on the document. Furthermore, the viewer user interface may include a “GPS” function that indicates location and page number of a given provision within the document.

When a formatted document has a relationship with other documents already formatted by the analyzer and formatter, embodiments of the present invention allow references in one formatted document to made to other formatted documents. These references may be cross-references, defined terms and definitions or section references to other documents stored locally or on a server. When appropriate, the outputted document may include links to publicly-available documents and texts, including, but not limited to, federal, state, and local statutes, federal and state legislation (proposed, pending and passed), federal and state rules and regulations, academic articles, comments and papers, and rules and publications of private organizations and accepted authorities.

In an embodiment of the present invention, the analyzer and formatter may create an index. The index may include defined terms, user-requested terms, and other phrases. The index may be based on “common concept” indexing—e.g., termination, remedies, indemnification, etc. Furthermore, the index may include a quick-tab column on right side of main panel listing numbering scheme allows for instant scrolling to the desired provision.

While several embodiments of the present invention have been illustrated and described herein, many changes can be made without departing from the spirit and scope of the invention. Accordingly, the scope of the invention is not limited by any disclosed embodiment. Instead, the scope of the invention should be determined from the appended claims that follow.

The embodiments of the invention in which an exclusive property or privilege is claimed are defined as follows:

1. A method of analyzing, formatting, and presenting a legal document comprising:
receiving an unformatted legal document in an electronic format at an electronic device;
parsing the document for structural elements of the legal document by a parser hosted on an electronic device; and
presenting a formatted document on an electronic device wherein the structural elements are identified to a user and the document is navigable by reference to the structural elements of the legal document.

2. The method of claim 1 wherein the formatted document is presented to the user as a navigable, marked-up document.

3. The method of claim 2 wherein the formatted document is a hypertext mark-up language (HTML) document.

4. The method of claim 1 wherein the parsing of the document further comprises the parsing the document for at least one of titles, section headings, definitions of terms, names of parties, dates, and cross references to other sections of the document.

5. The method of claim 1 wherein the parsing of the document further comprises parsing the document for at least one of references to other private or public, formatted or unformatted documents accessible during the parsing.

6. The method of claim 1 wherein the presenting of the formatted document is done by presenting the formatted document in a viewer window with a panel showing the history of the manipulations performed on the formatted document by at least the user or the parser.

7. A system for analyzing, formatting, and presenting a legal document comprising:
an electronic device for receiving an unformatted legal document;
an electronic device for parsing the document for structural elements of the legal document; and
an electronic device for presenting a formatted document wherein the structural elements are identified to a user and the document is navigable by reference to the structural elements of the legal document;
wherein these electronic devices are either directly or indirectly coupled to each other in such a way as to facilitate communication between these devices.

8. The system of claim 7 wherein the formatted document is presented to the user as a navigable, marked-up document.

9. The system of claim 8 wherein the formatted document is a hypertext mark-up language (HTML) document.

10. The system of claim 7 wherein the parsing of the document further comprises the parsing the document for at least one of titles, section headings, definitions of terms, names of parties, dates, and cross references to other sections of the document.

11. The system of claim 7 wherein the parsing of the document further comprises parsing the document for at least one of references to other private or public, formatted or unformatted documents accessible during the parsing.

12. The system of claim 7 wherein the presenting of the formatted document is done by the presenting the formatted document in a viewer window with a panel showing the history of the manipulations performed on the formatted document by at least the user or the parser.

13. A computer readable medium encoded with computer readable instructions, which when executed, perform a method for analyzing, formatting, and presenting a legal document comprising:
receiving an unformatted legal document;
parsing the document for structural elements of the legal document; and
presenting a formatted document wherein the structural elements are identified to a user and the document is navigable by reference to the structural elements of the legal document.

14. The computer readable medium of claim 13 wherein the formatted document is presented to the user as a navigable, marked-up document.

15. The computer readable medium of claim 14 wherein the formatted document is a hypertext mark-up language (HTML) document.

16. The computer readable medium of claim 13 wherein the parsing of the document further comprises the parsing the document for at least one of titles, section headings, definitions of terms, names of parties, dates, and cross references to other sections of the document.

17. The computer readable medium of claim 13 wherein the parsing of the document further comprises parsing the document for at least one of references to other private or public, formatted or unformatted documents accessible during the parsing.

18. The computer readable medium of claim 13 wherein the presenting of the formatted document is done by the presenting the formatted document in a viewer window with a panel showing the history of the manipulations performed on the formatted document by at least the user or the parser.
